(19) United States
(12) Patent Application Publication
(10) Pub. No.: US 2010/0276935 A1
(43) Pub. Date: Nov. 4, 2010

(54) RENEWABLE ENERGY FLUID PUMP TO FLUID-BASED ENERGY GENERATION

(75) Inventors: James G.P. Dehlsen, Montecito, CA (US); Christopher J. Grieco, Buellton, CA (US); William Peitzke, Montecito, CA (US)

Correspondence Address: Rankin, Hill & Clark LLP, 23755 Lorain Road, Suite 200, North Olmsted, OH, 44070, US

(73) Assignee: DEHLSEN ASSOCIATES, L.L.C., Carpinteria, CA (US)

(21) Appl. No.: 12/678,819

(22) PCT Filed: Jun. 3, 2008
(86) PCT No.: PCT/IB2008/001419

§ 371 Date: Jul. 14, 2010

Related U.S. Application Data
(60) Provisional application No. 60/994,741, filed on Sep. 20, 2007.

(51) Int. Cl. F03D 9/02; F03D 9/00; F04B 17/02

(52) U.S. Cl. 290/54; 417/334

(57) ABSTRACT

A wind or water turbine mounted atop a support tower or tethered underwater drives a hydro-pumping system. The turbine converts wind or water energy into a driving torque applied to the hydro-pump. The hydro-pump forces water through a pipe transmission system to an onshore facility. On shore, the resultant pressurized fluid-flow propels a hydroelectric generating system to produce electricity or may first be used in a Reverse Osmosis desalinization process and the byproduct in part used to propel a hydroelectric generating system to produce electricity. The cold-water discharge from the hydroelectric generating system and/or from the desalinization process is used for onshore district or power plant cooling purposes.

### FIELD OF THE INVENTION

The present invention relates to fluid-driven turbines and a method for operating such fluid-driven turbines, and more specifically, to a device and a method for converting the kinetic energy of the turbine driving fluid.

### DESCRIPTION OF THE PRIOR ART

Renewable energy power generation technology for offshore applications is based primarily upon wind turbines and recently emerging tidal, wave and ocean current turbines, all of which currently or are planned to drive electric generators and transmit power to shore via high-voltage electric submarine cables. This electrical equipment, with its many connections and electronic controls is expensive, requires a high degree of maintenance and is prone to malfunctioning and failures due to exposure to harsh elements and difficulty in accessing and servicing in an ocean environment with a wide range of sea states. Some of the problems mentioned above also occur with overhead high-voltage electric cables.

Multiple close-proximity, high voltage systems in single or multiple turbine configurations and their associated electromagnetic fields also carry many unknowns in terms of accelerating corrosion in salty water and electro-magnetic field (EMF) effects on marine life.

It is therefore an object of the present invention to provide a system for converting the kinetic energy of a fluid, and a method for operating such a device, which avoid the transmittal of power via high-voltage electric cables.

### SUMMARY OF THE INVENTION

The object of the invention is solved by a system for converting the kinetic energy of a first fluid, wherein the system comprises at least one fluid-driven turbine, each turbine driving at least one fluid pump for pressurizing a second fluid. The at least one fluid pump is connected to a transmission pipeline and provides the pressurized second fluid to the transmission pipeline, and the transmission pipeline is connected to at least one device for harnessing the energy of the pressurized second fluid.

Following, this specification uses the term “the turbine” and “the pump” for at least one turbine and at least one pump, i.e. the term “the turbine” is not restricted to only one turbine but also covers a plurality of turbines. The same applies for the term “the pump”.

The system of the present invention converts the kinetic energy of the first fluid, i.e. the fluid which drives the at least one turbine, by providing a pressurized second fluid. This pressurized fluid is piped to at least one device for harnessing the energy of the second fluid. This device can, for example, convert the energy of the pressurized fluid into electricity (a more detailed description will follow below). According to the invention, the energy is transported by this pressurized second fluid and therefore no high-voltage electric cables are necessary.

In general, the turbine of the system is located offshore, i.e. in or on a lake, a river or an ocean. The first fluid that drives said turbine is one or more of wind, ocean current, tidal current or river current, i.e. the turbine can be arranged under water (using water as first fluid) or above the water level (using wind as the first fluid). However, the turbine can also be arranged/situated onshore. In this case, the turbine is always driven by wind current.

The turbine drives the fluid pump for pressurizing a second fluid. Just like the turbine, the fluid pump can be arranged offshore or onshore. Independent from the arrangement of the turbine and the fluid pump, i.e. onshore, offshore, under water, or above water level, the second fluid pressurized by the fluid pump can be the same fluid as the first fluid, or the second fluid can differ from the first fluid.

For example, the first fluid and the second fluid are the same if the turbine and the pump are arranged under water and the pump is used to pressurize the water which drives the turbines. The second fluid and the first fluid differ if the turbine is wind driven, i.e. located above the water level and the fluid pump is used to pressurize water, for example from a nearby river or the ocean, if the turbine is arranged offshore but above the water level.

Although the turbine and the pump can be arranged onshore or offshore, it is preferred that both the turbine and the fluid pump are arranged offshore. Whether the fluid pump is arranged under water or above the water level depends on the current application. The same applies for the second fluid. Whether they are the same or differ depends on the application.

As mentioned above, the turbine is used to drive the fluid pump. The drive of the pump can be arranged mechanically or electrically. In the latter case, the rotary motion of the turbine is transferred to the fluid pump mechanically, for example with a gearing which connects the turbine with the fluid pump. However, it is also possible to drive the fluid pump with electricity. In this case the rotary motion of the turbine is used to generate electricity which drives the fluid pump. Whether the fluid pump is driven by electricity or mechanically depends on the application.

The device for harnessing the energy of the pressurized second fluid is usually an onshore device, wherein the pressurized fluid flow propels a hydro-device.

There are many ways and methods, respectively, to harness the energy of the pressurized second fluid. However, it is preferred that the device for harnessing the energy of the pressurized fluid is a device for producing electricity. In this case, the pressurized second fluid propels an electricity producing generator.

In an alternative embodiment the device for harnessing the energy of the pressurized fluid is a desalinization device. In this case, the fluid pressurized by the at least one pump is water.

In some cases it might be desirable to combine the possibilities of using the second fluid to produce electricity or using the second fluid in a desalinization device. Therefore, in one preferred embodiment of the invention the system comprises two devices for harnessing the energy of the pressurized second fluid, namely a device for producing electricity and a desalinization device, both devices being connected to the transmission pipeline, wherein the amount of pressurized fluid conducted through the devices is separately adjustable.

The desalinization device uses the pressurized water to produce salt-free drinking water. During the desalinization the relevant device produces a process stream of salt-free water with a low pressure. Furthermore, the desalinization device produces a brine stream with a relatively high pressure. To harness the remaining energy of the high pressure brine stream the desalinization device is arranged upstream of the device for producing electricity, so that a pressurized brine flow or stream of the desalinization device can be piped to the device for producing electricity.

Independent from the first usage of the pressurized second fluid, i.e. independent from using the second fluid to propel an electricity generating device or from using the pressurized fluid in a desalinization device, the discharge flow from this device or these devices (if the system comprises more than one device for harnessing the energy of the second fluid) still contains usable “energy” since the discharge flow has a very low temperature. Therefore, it is preferred that the system comprises a downstream water utility, in which cold water discharged from the at least one device for harnessing the energy of the pressurized fluid is used for cooling processes.

At least when an ocean current is used to drive the turbine of the system, the system substantially constantly converts the kinetic energy of the first fluid. However, the need for the pressured second fluid is not that constant. For example, if the system is used to produce electricity, the need for this electricity decreases, for example, at night. During such off peak hours the energy of the second fluid can be used for district cooling and the production of fresh water. However, in a preferred embodiment of the invention the system comprises an air-filled energy storage connected to the transmission pipeline, wherein the air in the storage can be compressed by injecting water in the energy storage.

With this embodiment of the invention, the energy of the second pressurized fluid can, for example, be stored during off peak hours. If, for example, the demand for electricity increases, the pressure in the energy storage can be used to pipe additional pressurized fluid to the device(s) for harnessing the energy of the pressurized fluid.

The object of the invention is also solved by a method for converting the kinetic energy of wind or water. The method comprises the steps of using the kinetic energy of wind or water to drive a turbine, using the energy provided by the turbine to drive a pump for pressuring a fluid, and piping the pressurized fluid through a transmission pipeline to at least one device for harnessing the energy of the pressurized fluid.

The energy of the pressurized fluid can be used in a number of ways. However, in times of an increasing demand for electricity, it is preferred that the pressurized water is piped into a hydroelectric facility for generation of electricity.

A lot of countries do not have enough fresh water resources. Therefore, ocean water is often desalinated to produce fresh drinking water. Therefore, it is preferred that the pressurized water is piped to a desalinization device, wherein the pressurized water passes through a filtering process, producing a low pressure, fresh water-flow and a high pressure, brine flow.

The brine flow can be discharged. However, the brine flow sill comprises usable energy since the brine flow has a high pressure. Therefore, it is preferred that the brine flow is piped into the hydroelectric facility for generation of electricity.

Even the fresh water flow contains a residue of usable “energy”, since the temperature of the fresh water flow is quite low. Therefore, it is preferred that the fresh water flow is piped to a water utility for drinking or irrigation water and/or cooling processes.

The same applies for the brine flow, i.e. the brine flow comprises a remainder of usable energy in form of coldness. In a preferred embodiment the brine flow discharged from the hydroelectric facility is directly used for cooling processes or piped to the water utility (for cooling processes).

The invention has the advantage that the turbine captures or concentrates large volume, slow-flow wind or water currents, i.e. the kinetic energy of the first fluid, and converts them to high-pressure, high flow-rate energy (i.e. the second fluid) which is piped to at least one device for harnessing the energy of the pressurized fluid. Since no high-voltage cables are needed the maintenance costs are reduced.

The invention has significant environmental benefits. The completely hydraulic system involves no electricity consumption, which reduces air pollution and greenhouse gas production. In addition, the ability to provide cold water for refrigeration and other cooling systems significantly offsets the greenhouse gases otherwise created in producing and using conventional fossil fuels to power these systems.

This novel fluid-drive system has significant reliability advantages over generating electricity offshore and transmitting electric power to shore. High-voltage systems in a marine environment can be problematic.

The invention has the advantage that wind or water current turbines, which drive water pumps, allow for much greater machine simplicity and reduction of electricity-related components, which greatly enhance turbine productivity and reliability.

The invention has the advantage that in addition to generating electricity, the fluid-drive system also has the flexibility to provide shore-based cooling capacity, desalinization, and aquaculture resources; the latter due to the potential in some locations to gather and pump cold and more nutrient-filled water onshore.

The invention has the advantage that system utility is further augmented by an energy storage feature, which allows for optimizing the balance of systems outputs to best fulfill the customers' needs.

The invention has the advantage that the delivered power produced from ever-present ocean currents does not have to be sold in the form of 100% electricity during off peak hours. The power can used to produce energy for district cooling and can produce fresh water as a commodity when revenue capture for electricity off peak is low.

The invention has the advantage of programmable system outputs whereby the user may choose to vary the use of the pressurized water.

### BRIEF DESCRIPTION OF THE DRAWINGS

The invention will be described in detail with reference to the drawings in which:

FIG. 1 is an overall block diagram of an embodiment of the fluid-flow system in which the invention is embodied;

FIG. 2A is a diagram of an onshore portion of the fluid-flow system shown in FIG. 1;

FIG. 2B is a diagram of a wind turbine on a tower, anchored in a body of water, and connected to the fluid-flow system of FIG. 2a;

FIG. 3 is a diagram of a water current turbine on an underwater tower anchored in a body of water, and connected to the onshore portion of FIG. 2A;

FIG. 4 is a diagram of a water current turbine tethered underwater, and connected to an onshore portion;

FIG. 5 is a more detailed diagram of one of the water current turbines shown in FIG. 4;

FIG. 6 is a diagram of an underwater array consisting of a plurality of turbine modules;

FIG. 7 is a rear perspective view of the water current turbines shown in FIG. 5;

FIG. 8 is a front perspective view of the water current turbines shown in FIG. 5;

FIG. 9 is a rear view of the water current turbines shown in FIG. 5;

FIG. 10 is a side elevation view of the water current turbines shown in FIG. 5; and

FIG. 11 is a top plan view of the water current turbines shown in FIG. 5.

In these figures, similar numerals refer to similar elements in the drawings. It should be understood that the sizes of the different components in the figures may not be to scale, or in exact proportion, and are shown for visual clarity and for the purpose of explanation.

### DESCRIPTION OF THE PREFERRED EMBODIMENTS

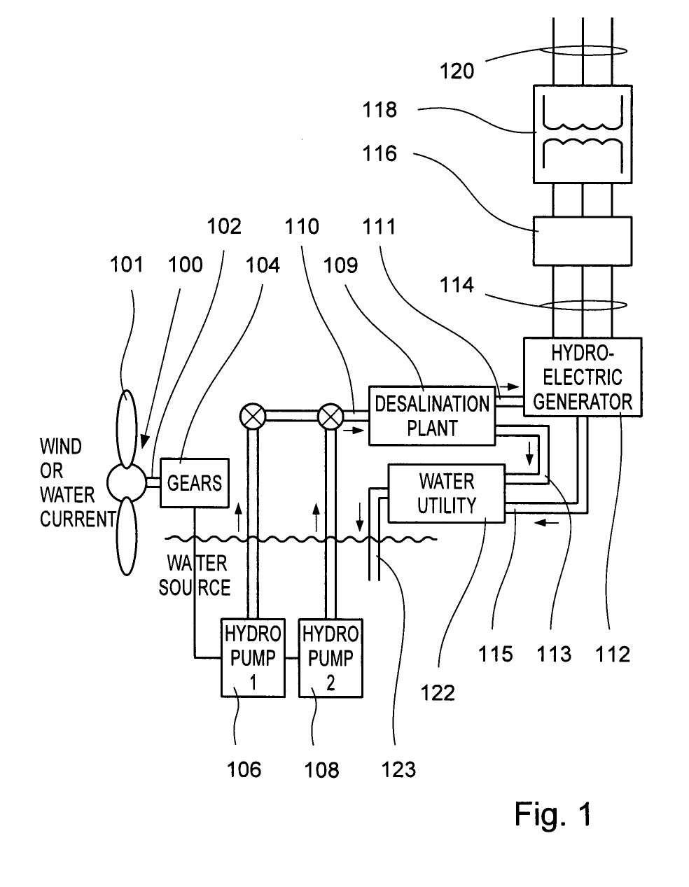

FIG. 1 illustrates an embodiment of a system for converting the kinetic energy of a first fluid. The system of FIG. 1 comprises one fluid-driven turbine (100, 102, 104) which drives two fluid pumps (106, 108) for pressurizing water. The fluid pumps are connected to a transmission pipeline (110) and provide the pressurized water fluid to the transmission pipeline, wherein the transmission pipeline (110) is connected to hydroelectric generator (112), i.e. a device for harnessing the energy of the pressurized water.

In other words, FIG. 1 illustrates a system wherein energy harnessed by a fluid-driven turbine (100, 102, 104) transmits energy via pressurized fluid flow to an onshore station wherein the pressurized fluid flow propels the hydrodevice (112). The device (112) may be any energy recovery device, such as a hydroelectric generating system that produces electricity, a desalinization plant (109) for filtering out fresh water for drinking or irrigation (fresh water stream 113), a cold water repository for use in district (air conditioning) cooling system, a brine Pelton turbine or any combination of the above.

The embodiment according to FIG. 1 comprises two devices for harnessing the energy of the pressurized water, namely the hydroelectric generator (112) and a desalination device (109). Furthermore, the system of FIG. 1 comprises a water utility (122).

The desalination device (109) is provided upstream of the hydroelectric generator (112) and is connected to the transmission pipeline (110). The pressurized water enters the desalination device (109), where it is separated in high pressure brine flow (111) and a low pressure fresh water flow (113). The high pressure brine flow is piped to the hydroelectric generator (112) and propels the generator to produce electricity. In the embodiment shown in FIG. 1 the fresh water flow is piped to a water utility where the low temperature of the fresh water flow is used for cooling processes.

In other embodiments of the invention even the brine flow discharge from the hydroelectric generator can be piped to the water utility (122) if the temperature is low enough to use the brine flow for cooling processes. Furthermore, in other embodiments the system can only comprise one device for harnessing the energy of the pressurized water, for example only the hydroelectric generator. However, it is preferred to combine a desalination device with a hydroelectric generator since the energy needed for operating the desalination device can be produced by the hydroelectric device and must not be taken from a public power grid.

Furthermore, in other embodiments of the system the transmission pipeline can be connected to the desalination device and the hydroelectric device so that the amount of pressurized fluid delivered to the separate devices can be controlled and adapted to the needs of the market. For example, during off peak hours more pressurized water can be used to produce fresh water.

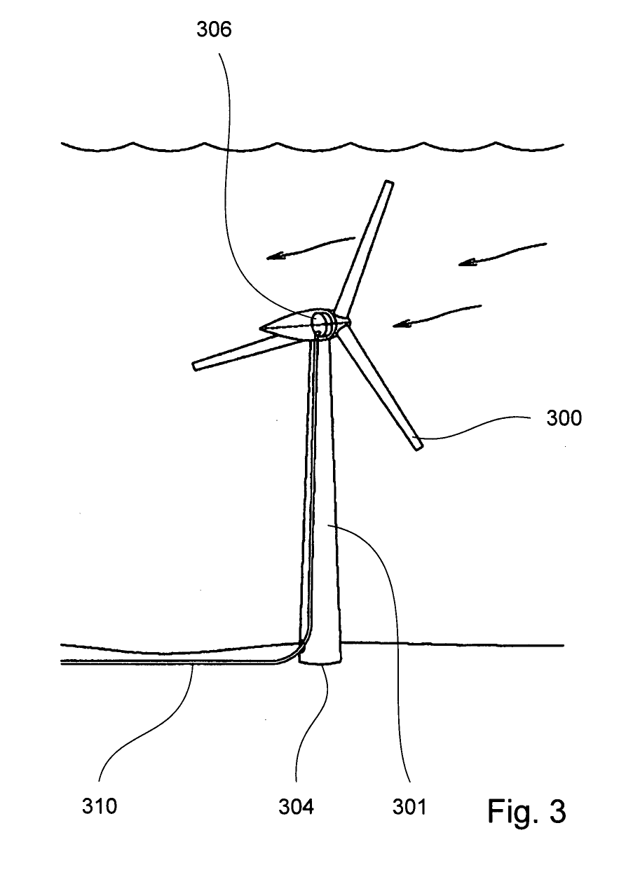

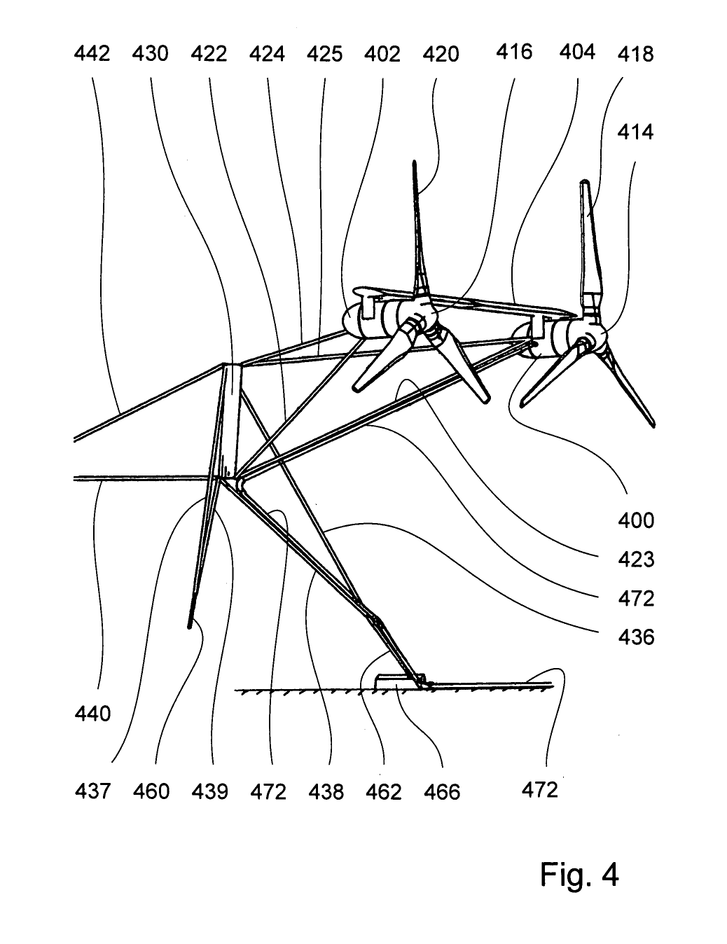

The fluid that drives the turbine is not restricted to wind current as it is illustrated in FIG. 1. One or more of wind, ocean current, tidal current or river current can be used. The devices may be above water (wind driven, FIG. 1) or below water (ocean current driven, FIGS. 3 and 4) in operation and the pumping systems either in atmospheric, pressure vessel or submersible environs. The water (115) discharged from the hydro device (112) can be used in a water utility (122) and may then be returned (123) to the water source.

The turbine includes a rotor (100) that turns a rotating shaft (102) connected to a torque reducing gear (104). The torque-reducing gear (104) is preferably a distributed-power train as described in U.S. Pat. No. 7,069,802 B2 to Mikhail, et al. The rotor (100) and gear (104) can, for example, be mounted atop a tower structure anchored to the ocean, river or lake floor. The rotor (100) is maintained in the horizontal plane and into the path of prevailing wind or water current by a yaw control mechanism. The rotor (100) has blades (101), which rotate in response to fluid flow. Each blade has a blade base section attached to the rotor shaft that drives the gears and may have blade pitch angle control capability and/or a blade extension section that is variable in length to provide a variable diameter rotor. The rotor diameter may be controlled by extending or retracting the blade extensions to fully extend the rotor at low flow velocity and to retract the rotor as flow velocity increases such that the loads delivered by or exerted upon the rotor do not exceed set limits. The pitch of an entire blade may be varied while only a portion of the blade is extended.

The torque distributing gears (104) drive one or more underwater hydro-pumps (106, 108), which are driven by the rotor (100) to produce water pressure in water-carrying pipe 110. The pipeline (110) can be inter-connected to (not shown) other units and/or to an onshore desalinization system (109), a hydro-electric generating system (112), a district cooling system or some combination of the above. The resultant pressurized fluid-flow propels the hydro-electric generating system (112) to produce electricity (114). A protection device (116), such as a circuit breaker and/or fuse can be provided for isolation in case of a fault. A pad-mount transformer (118) changes the voltage of power produced to the voltage of an energy farm collection system (120) that is connected to a power grid.

The distributed-power train (104) can be used to drive generators in a wind turbine as described, in U.S. Pat. No. 7,069,802 B2 to Mikhail, et al. to produce electricity to electrically power pumps (106, 108), at the base of a tower, upon which the wind turbine is placed. In this case, the pumps (106, 108), can be placed in the water as shown in FIG. 1 or on shore with appropriate piping to the water source. However, the pumps can also be driven mechanically as will be described below.

After desalination, there is minimal pressure left in the fresh water stream (113). Therefore, in another embodiment of the system the fresh water stream (113) can be used for hydro turbines. This fresh water (113) can either be sold as is or run through a heat exchanger to extract temperature value, then sold as fresh for drinking/irrigation/etc. The brine stream (111) does have pressure to it and runs through the hydroelectric generator (112). If it has cool temperatures left, the AC/cooling value can be extracted by running the brine (115) though a cooling system, then the brine can be disposed of.

The cold-water discharge (115) from the hydroelectric generating system (112) is used to provide energy to water utility (122), such as refrigeration and is then returned (123) to the water source.

An enhancement to the system is that if a desalinization plant (109) is provided on site, the pressurized water flow (110) can be diverted to by-pass the desalinization plant (109) and enter the hydro electric generator (112) directly to obtain 100% hydro electric generation from the flow (111).

To summarize, the pressurized sea water source (110) may first enter a desalinization device (109) whereby the source water passes through a filtering process, producing a low pressure, fresh water flow (113) and a high pressure, brine flow (111). The brine flow (111) can be piped into a hydroelectric facility (112) for generation of electricity. The fresh water flow (113) may be used by the water utility (122) for drinking or irrigation water and energy for refrigeration and the brine flow (115) discharged from the hydroelectric facility (112) may be used for energy for refrigeration before being disposed of.

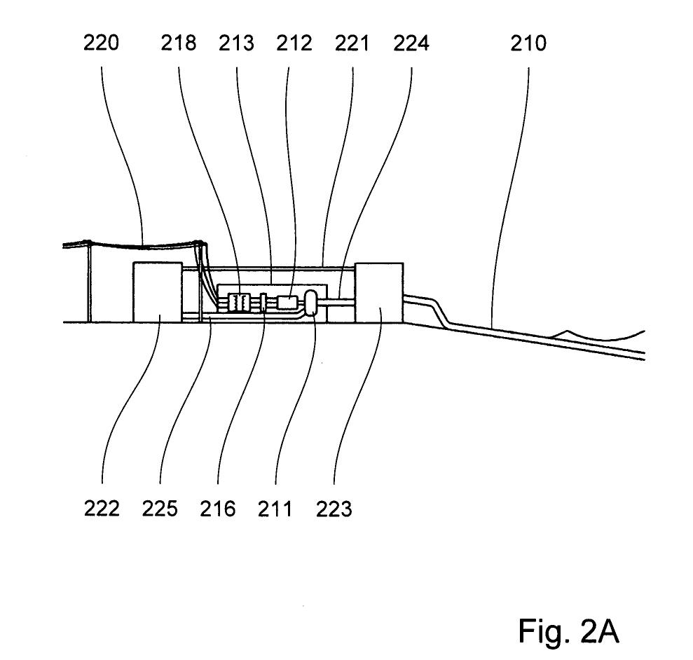

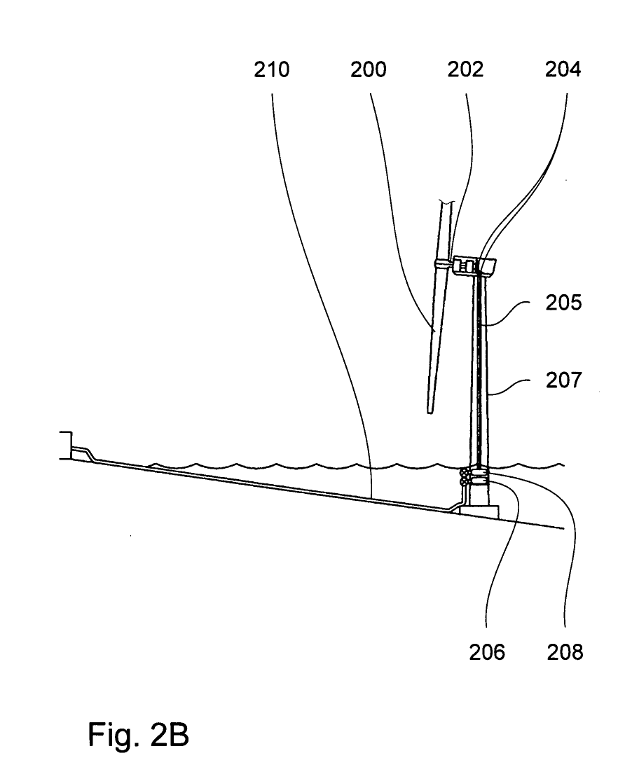

Refer to FIG. 2A, which is a diagram of an onshore portion of the embodiment of the fluid-flow system shown in FIG. 1. A high-pressure seawater pipe (210) from a wind turbine shown in FIG. 2B enters a desalinization plant (223). High-pressure cold brine is discharged via cold brine discharge pipe ((224)). Fresh water (221) separated by the desalinization plant (223) is routed by fresh water pipe (221) to water utility (222).

The high-pressure cold brine (224) drives a water turbine (211), the output shaft of which turns a generator (212), which is a component of a hydroelectric plant (213). Cold brine discharge (225) from the water turbine 211 is routed to the water utility (222).

The pressurized water flow can be diverted to by-pass the desalination plant (223) and obtain 100% hydro-electric generation from the flow. The by-pass can be done in a known manner by valves and a by-pass pipe within the desalination plant (223).

The hydroelectric plant (213) includes electrical equipment (216) necessary to provide appropriate voltage and current to a transformer (218). Transformer (218) is connected to high-tension electrical wires (220).

Refer to FIG. 2B, which is a diagram of a wind turbine on a tower, anchored in a body of water, and connected to the fluid-flow system of FIG. 2A. With this embodiment the turbine drives water pumps (206, 208) mechanically. A mechanical drive of the water pumps (206, 208) is achieved as follows. Rotor blades (200) turn a main shaft (202), which drives right-angle gears (204) connected to a down shaft (205), and the down shaft (205) drives the water pumps (206, 208). The water pumps, which are open to the body of water, pump water through high-pressure seawater pipe (210) from the water current turbine to the onshore system shown in FIG. 2A.

Refer to FIG. 3, which is a diagram of a water current turbine on an underwater tower (301) anchored (304) in a body of water, and connected to the fluid-flow system of FIG. 2A. Rotor blades (300) turn a main shaft, which drives the water pump (306). The water pump (306), which is open to the body of water, pumps water through high-pressure seawater pipe (310) from the water current turbine to the onshore system shown in FIG. 2A.

FIG. 2B illustrates a wind power-generating device. The wind power-generating device is mounted atop a tower structure (207) anchored to the floor of a body of water. A rotor (200) is maintained in the horizontal plane and into the path of prevailing wind current by a yaw control mechanism. The rotor has variable pitch blades, which rotate in response to wind. Each blade has a blade base section attached to a rotor shaft (202) and may have blade pitch angle control capability and/or a blade extension section that is variable in length to provide a variable diameter rotor. The rotor diameter may be controlled by extending or retracting the blade extensions to fully extend the rotor at low flow velocity and to retract the rotor as flow velocity increases such that the loads delivered by or exerted upon the rotor do not exceed set limits. The pitch of and entire blade may be varied while only a portion of the blade is extended.

The power-generating device is held by the tower structure in the path of the wind current such that the rotor (200) is held in place horizontally in alignment with the wind current.

The gears (204) drive one or more underwater hydro-pumps (206), which are driven by the pump drive shaft (205) to produce water pressure in water-carrying pipes (210), which can be inter-connected to other units and/or to an onshore water turbine (211). The water turbine (211) drives a generator (212) to produce electricity.

The cold-water discharge (222) from the water turbine (211) is used to provide power to a water utility, such as for refrigeration and is then returned to the source.

Alternatively, the pressurized water source may first enter a desalinization device whereby the source water passes through a filtering process, producing a low pressure, fresh water flow and a high pressure, brine flow. The brine flow can be piped into a hydroelectric facility/device for generation of electricity. The fresh water flow may be used by the water utility for drinking or irrigation water and energy for refrigeration and the brine flow may be used for energy for refrigeration before being disposed of.

FIG. 3 illustrates a water power-generating device. The water power-generating device is mounted atop a tower structure (301) completely under water and anchored (304) to the floor of the body of water. The turbine rotor (300) is maintained in the horizontal plane and into the path of prevailing water current by a yaw control mechanism. The rotor has variable pitch blades (306), which rotate in response to water current.

The rotor drives one or more underwater hydro-pumps (306), which are driven by the rotor (300) to produce water pressure in water-carrying pipes (310), which can be inter-connected to other units and/or to an onshore water turbine (as shown in FIG. 1). The water turbine drives a generator to produce electricity.

The cold-water discharge from the water turbine is used to provide refrigeration and is then returned to the source as described above with respect to FIG. 2.

Alternatively, the pressurized water source may first enter a desalinization process/device whereby the source water passes through a filtering process, producing a low pressure, fresh water flow and a high pressure, brine flow. The brine flow can be piped into a hydroelectric facility for generation of electricity. The fresh water flow may be used by the water utility for drinking or irrigation water and energy for refrigeration and the brine flow may be used for energy for refrigeration before being disposed of.

### Other Outputs, Refrigeration, District Air Conditioning, Desalinization and Aquaculture

The fluid-drive system may include a refrigeration phase based on the cold water being drawn from the deeper areas of the ocean (or lake) by the turbine(s)-driven pump(s) and transferred to the shore-based hydroelectric station for power generation. The station's cold ocean or lake water system may also be used for cooling applications, such as augmenting the cooling capacity of thermal generating plants or for a central cooling system for residential, commercial, or other industrial uses. The fluid-drive system may also be used for direct desalinization on-shore or at the offshore location of the wind turbine or ocean current turbine. Aquaculture benefits may be found in that the cold seawater in certain locations is nutrient rich and more pure.

### Underwater System with Fluid or Compressed Air Pumping

FIG. 4 is a rear, side view in perspective of an underwater tethered device in which a part of the present invention is embodied. An underwater tethered device is described in U.S. provisional application 60/937,813 of Dehlsen, et al, filed on Jun. 29, 2007. The system includes a strut (430) and a device (400, 402) connected by device tethers (422, 423, 424, 425) to the strut (430). The strut is moveable to control depth of the device. A main tether (not shown but connected to tethers 440 and 442), a left side tether (462) and a right side tether (460), anchor the strut to the ocean floor. One of the tethers is a variable length tether.

A length control is connected to the variable length tether. The length control is a winch in the strut (430) for controlling tension on the variable length tether. When the variable length tether is wound upon the winch, the device is lowered and when the variable length tether is unwound from the winch, the device is raised by buoyancy of the device and the strut.

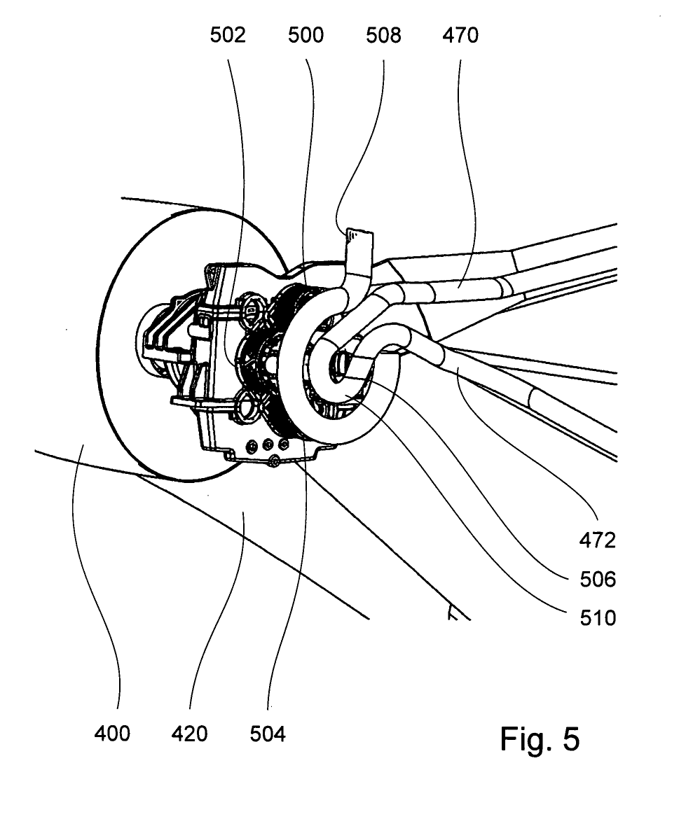

The underwater device includes a pair of hydro pumps housed in fluid-tight nacelles (400) and (402), which are connected together by a hydrofoil wing structure, which consists of a central section (404). The hydro-pumps are shown more clearly in FIG. 5. A cross pipe (470) through the central section (404) connects together the outputs of the hydro pumps in each nacelle. A down pipe (472) along the tether line (423, 438) brings the combined nacelle outputs down to the strut (430) and from the strut, down to an anchor (466), and from the anchor to shore, along the ocean floor.

The control section (404) positions and supports the nacelles (400) and (402) on the lower surface of the central section (404) with each of the nacelles located underneath the central hydrofoil structure (404).

Each turbine has a rotor (414, 416) with variable pitch blades, (418) and (420), respectively, which rotate in opposite directions so that the torque forces on the structure balance. A pair of tethers (422, 424) tethers the device (402) underwater in the path of the water current. A pair of tethers (423, 425) tethers the power-generating device (400) underwater in the path of the water current. The tethers (422-425) are referred to as “device tethers”. The rotors (414) and (416) are positioned relative to the hydrofoil (404) such that water current first moves past the central section (404), then engages, and causes rotation of the rotors (414) and (416). The device tethers (422-425) extend from tether-connecting members, on the body of each nacelle (400) and (402), to a cable strut (430).

Refer to FIG. 5, which shows the hydro-pumps within the nacelles of FIG. 4. Four hydro pumps (500, 502, 504, 506) are shown connected to a water inlet or air snorkel (508). The cross pipe (470) shown in FIG. 4 is connected to a water outlet pipe (510). Four outputs of the hydro pumps (500, 502, 504, 506) are connected to the water outlet pipe (510), which connects to the down pipe (472) shown in FIG. 4.

Water or air is pumped in from the inlet (508) by the hydro pumps (500, 502, 504, 506) and forced out the outlet pipe (510) to the down pipe (472), to the ocean floor and along the ocean floor to land-based facilities.

### Underwater Fluid Or Compressed Air Array

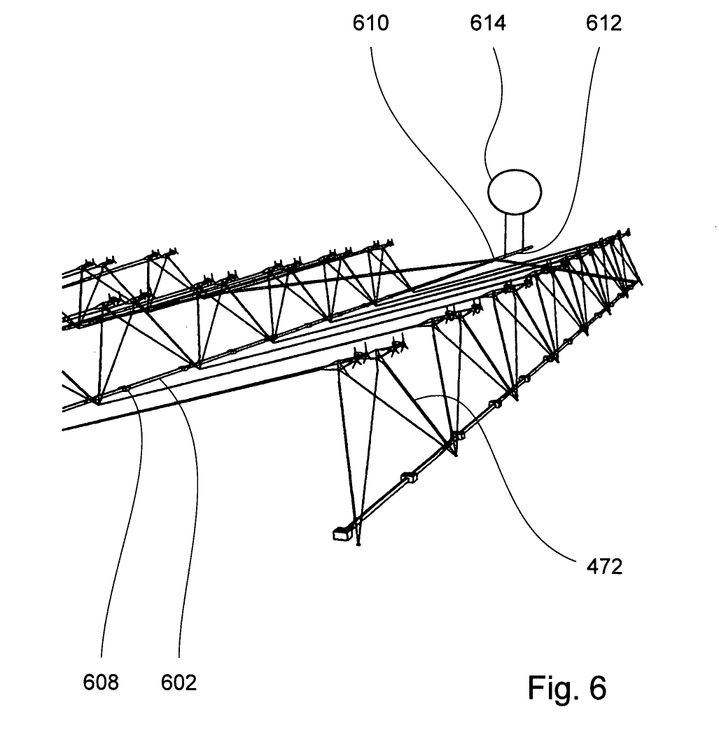

Refer to FIG. 6, which is a diagram of an underwater array consisting of a plurality of turbine modules. The array consists of a number of the turbine modules of FIG. 4 anchored to the ocean floor in the pattern shown. The water or compressed air down pipes (472) shown in FIG. 4 are connected to common transmission pipes (600, 602), which are anchored to the ocean floor by anchors (604, 608). The common transmission pipes (600, 602), are connected to a manifold (610), the output of which is a common output pipe (612) going to shore.

An accumulator (614) is provided at the output pipe (610) to integrate energy storage capacity into the system, in the form of a network of large diameter air-filled “storage” pipes or bladders resting on or tied to the ocean floor. The turbines are used to pressurize the storage accumulator (614) through injection of water into the air-filled cavities of the energy storage network. Thus, a reserve of stored energy in the form of compressed air may be used to drive water for the shore-based generating facility.

Each fluid-driven turbine transmits pressurized fluid flow to a common manifold (600, 602, 610), which in turn delivers the pressurized fluid flow by way of a transmission pipeline (612) to an onshore station, wherein the pressurized fluid. flow propels a hydro-device for large-scale commercial power generation.

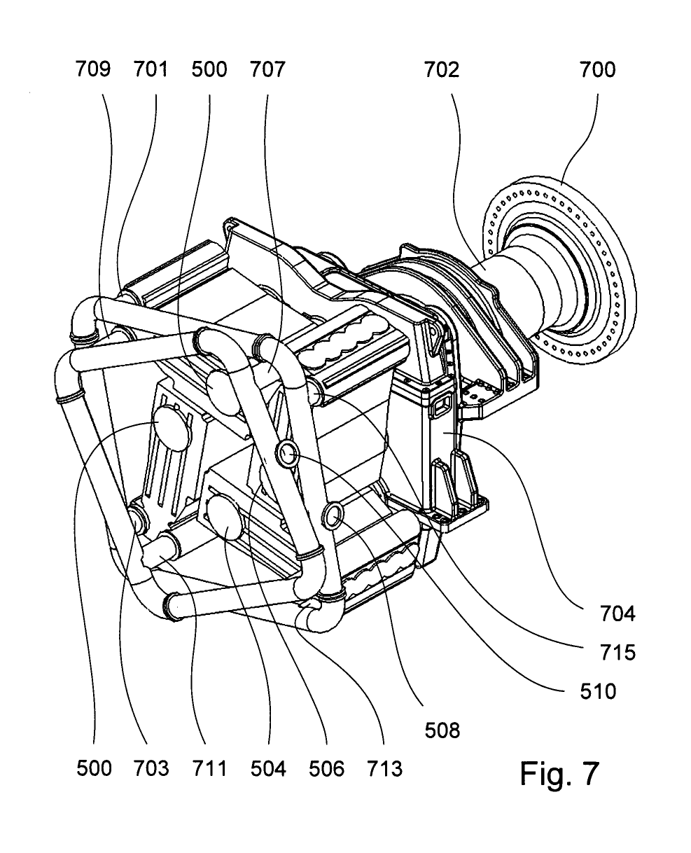

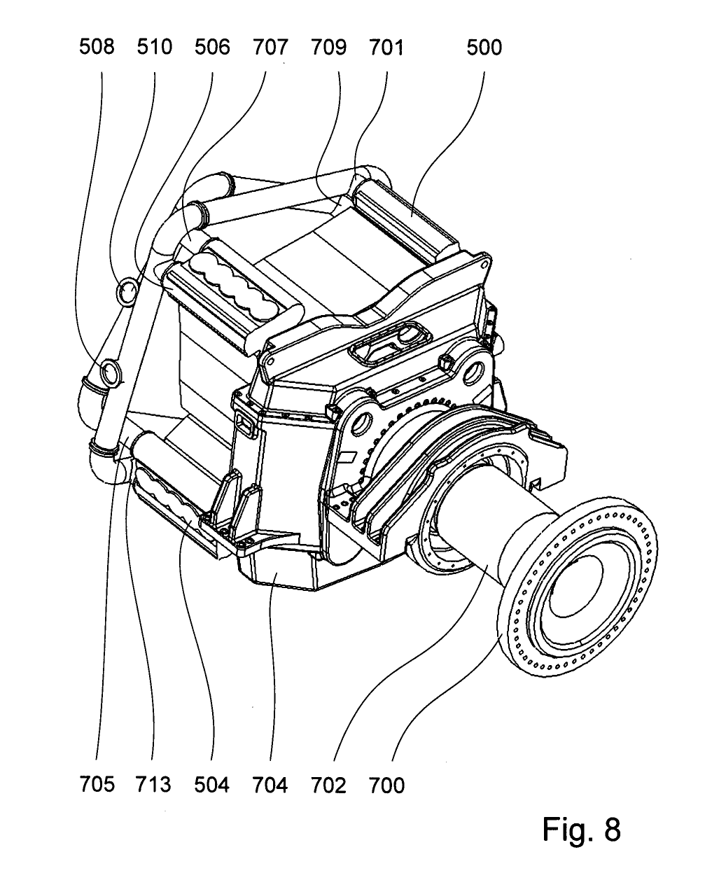

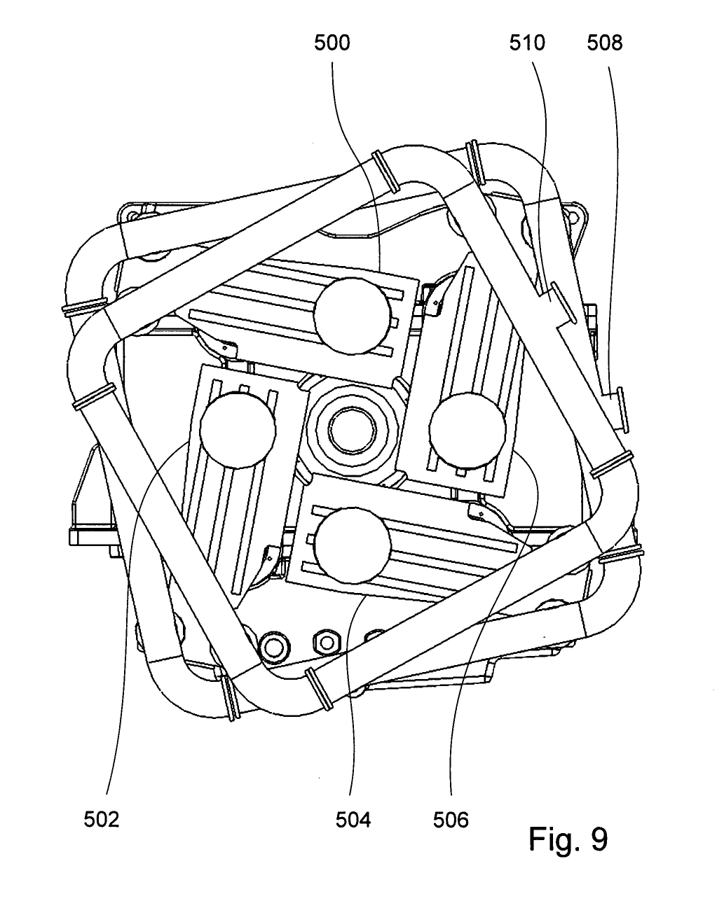

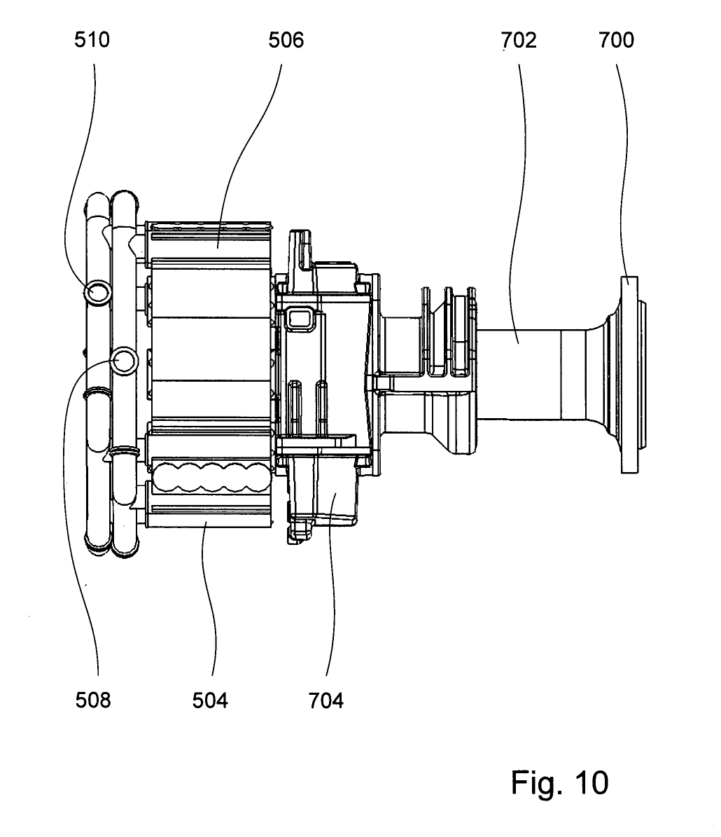

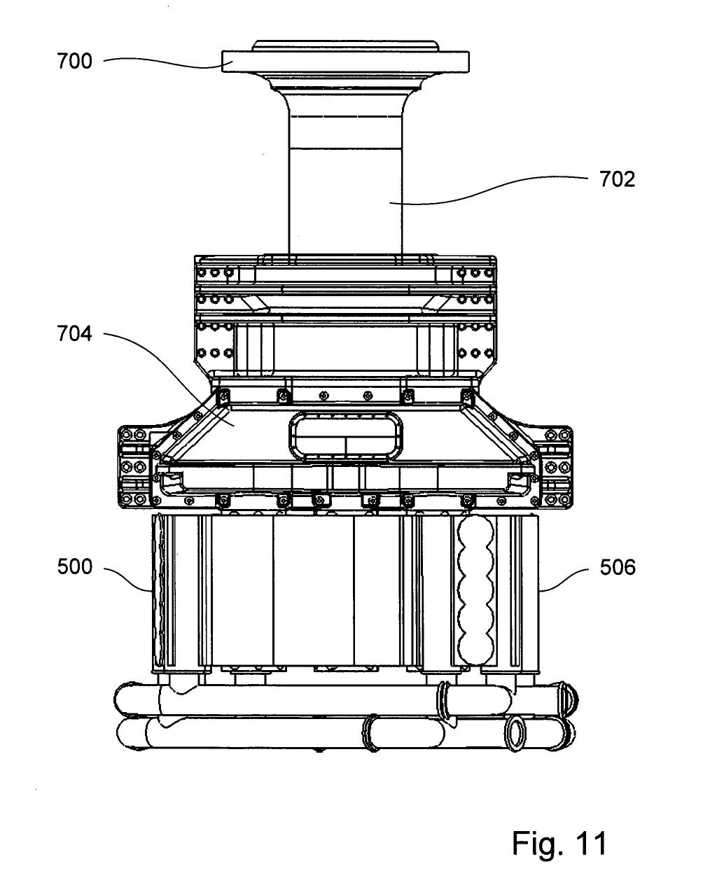

Refer to FIGS. 7-11, which are more detailed diagrams of the water current turbines shown in FIG. 5 and FIG. 6. Four hydro pumps (500, 502, 504, 506) are shown connected to a water manifold inlet or air snorkel manifold entry point (508).

Four (701, 703, 705, 707) inputs of the hydro pumps (500, 502, 504, 506) are connected to the water inlet manifold connecting the inputs of the hydro pumps (500, 502, 504, 506) to manifold entry point (508), which connects to the pipe (470) shown in FIG. 4. The cross pipe (470) shown in FIG. 4 is connected to a water outlet pipe (510). Four outputs (709, 711, 713, 715) of the hydro pumps (500, 502, 504, 506) are connected to the water outlet manifold directing the outputs of the hydro pumps (500, 502, 504, 506) to outlet pipe (510), which connects to the down pipe (472) shown in FIG. 4.

Water or air is pumped in from the inlet (508) by the hydro pumps (500, 502, 504, 506) and forced out the outlet pipe (510) to the down pipe (472), to the ocean floor and along the ocean floor to land-based facilities.

The turbine includes a rotor-driven hub flange (700) that turns a rotating shaft (702) connected to a torque reducing gear (704). The torque-reducing gear (704) is preferably a distributed power train as described in U.S. Pat. No. 7,069,802 B2 to Mikhail, et al. Alternate drive systems, pump arrangements and manifold systems may be employed with single or multiple turbines to achieve varying physical package benefits and varying production output. Such arrangements are dependent on case-specific energy needs, turbine sizes, and the nature of the application onshore.

The torque distributing gears (704) drive the underwater hydro-pumps (500, 502, 504, 506), which are driven by the rotor-driven hub flange (700) to produce water pressure in water-carrying pipes inter-connecting to other units and/or to an onshore hydro-electric generating system, a desalinization system, a district cooling system or some combination of the above. The resultant pressurized fluid-flow propels a hydroelectric generating system to produce electricity.

### Energy Storage

The utility of the fluid-drive system may be further enhanced by integrating energy storage capacity into the system, in the form of a network of large diameter air-filled “storage” pipes or bladders resting on or tied to the ocean floor. The turbines in all cases (wind and water) may be used to pressurize the storage pipes or bladders through injection of water into the air-filled cavities of the energy storage network. This has the advantage that during times when wind levels are diminished, a reserve of stored energy in the form of compressed air may be used to drive water for the shore-based generating facility. For tidal, river or ocean current turbines, this storage is valuable because this renewable source runs around the clock at times when the demand for electricity is at its lowest (price). Storing rather than immediately delivering this energy to create electricity onshore optimizes value for revenue and grid stabilization because the system may be commanded to transmit the energy when most needed.

With this energy storage feature, power delivery from the system becomes dependable and dispatchable versus the intermittent nature of conventional wind power. It is optimal for ocean current turbines, which operate in constant flow environments when the grid market is “off-peak”. A further benefit of this capability is to allow a time-shift of the delivery of electricity from “as produced” by the turbine, to delivery of electricity during the hours of the day with greatest electricity value (“peak hours”). As an example, an offshore wind farm could be programmed for pumping 18 hours per day to charge the air pressure of the pipe storage network and then during the six hours of high electricity need (high priced), the stored energy in the form of pressurized air, is released for conversion and delivery of electricity. In this example, the electricity produced at the on-shore hydroelectric station would be about three times greater than the capacity of the wind turbines, however, the power delivery at these elevated levels would last only 25% as long, and also require capacity of pipes to shore and shore-based generating capacity about three times greater than “as produced” capacity. The higher revenues from peak-load electricity pricing should exceed the added cost of this greater capacity.

### Programmed Controls to Optimize Outputs

The fluid-drive system can be controlled through programmed algorithms, which allow a city or municipality to optimize the time of day for grid delivery, seasonal adjusted generation, reserve generating capacity, and other features relating to the production and delivery of electricity, potable water, and cooling water. The system also provides the flexibility of starting with a single function; i.e., electricity generation, and adding other features, as needed.

### Alternative: Electrical Generators Powering Hydro Pumps

As described with respect to FIG. 1 a turbine that includes a rotor (100) turns a rotating shaft (102) connected to a torque reducing gear (104). The torque-reducing gear is preferably a distributed-power train as described in U.S. Pat. No. 7,069,802 B2 to Mikhail, et al. The rotor and gear are mounted atop a tower structure anchored to the ocean, river or lake floor. The gears drive hydro pumps (106, 108) which are under water.

In an electrical power-generating turbine the gears (104) drive electrical generators that produce electricity. In this alternative, instead of gear's shafts directly powering the hydro pumps (106, 108), the electrical generators power the hydro pumps (106, 108), which have electrical motors in series with the pumps. The balance of the transmission and onshore systems remain consistent with the materials herein.

1. A system for converting the kinetic energy of a first fluid into pressurized second fluid, wherein the system comprises:
at least one fluid-driven turbine,
each turbine driving two or more hydro pumps for pressurizing a second fluid and comprising:
a manifold entry point;
inputs of said hydro pumps being connected to said manifold entry point;
a down pipe
outputs of said hydro pumps being connected to an outlet manifold directing the outputs of the hydro pumps to an outlet pipe, which connects to said down pipe; and
wherein the down pipe is connected to at least one device for harnessing the energy of the pressurized second fluid.

2. The system of claim 1, wherein the device for harnessing the energy of the pressurized fluid is a device for producing electricity.

3. The system of claim 1, wherein a cross pipe connects the outlet pipe of one turbine with the manifold entry point of a second turbine.

4. The system of claim 3, wherein the second fluid is water and the device for harnessing the energy of the pressurized fluid is a desalinization device.

5. The system of claim 2, wherein the system comprises two devices for harnessing the energy of the pressurized second fluid, namely a device for producing electricity and a desalinization device, both devices can be connected to the transmission pipeline, wherein the amount of pressurized fluid conducted through the devices can be adjusted separately.

6. The system of claim 4, wherein the desalinization device is arranged upstream of the device for producing electricity, so that a pressurized brine flow of the desalinization device can be piped to the device for producing electricity.

7. The system of claim 3, wherein the system comprises a downstream water utility, in which cold water discharged from the at least one device for harnessing the energy of the pressurized fluid is used for cooling processes.

8. The system of claim, wherein the system comprises an air-filled energy storage connected to the transmission pipeline, wherein the air in the storage can be compressed by injection water in the energy storage.

9. A method of converting the kinetic energy of wind or water, the method comprises the steps of:
using the kinetic energy of wind or water to drive a turbine, which divides the energy into two or more paths,
using the energy provided by the turbine to drive a pump for pressuring a fluid, and,
connecting outputs of the hydro pumps to a water outlet pipe, and
piping the pressurized fluid through a transmission pipeline to at least one device for harnessing the energy of the pressurized fluid.

10. The method of claim 9, wherein the pressurized water is piped into a hydroelectric facility for generation of electricity.

11. The method of claim 9, wherein the pressurized water is piped to a desalinization device, wherein the pressurized water passes through a filtering process, producing a low pressure, fresh water flow and a high pressure, brine flow.

12. The method of claim 11, wherein the brine flow is piped into the hydroelectric facility for generation of electricity.

13. The method of claim 12, wherein the fresh water flow is piped to a water utility for drinking or irrigation water and/or cooling processes.

14. The method of claim 13, wherein the brine flow discharged from the hydroelectric facility is used for cooling processes or piped to the water utility.

15. A system wherein energy harnessed by a fluid-driven turbine transmits energy via pressurized fluid flow to an onshore station wherein the pressurized fluid flow propels a hydro-device.

16. The system of claim 15, wherein said pressurized fluid flow is water.

17. The system of claim 15, wherein said pressurized fluid flow is compressed air.

18. The system of claim 15, wherein said hydro-device is a hydroelectric generating system that produces electricity.

19. The system of claim 15, wherein said hydro-device is a desalinization system producing fresh water and a brine-flow, which is used to produce electricity.

20. The system of claim 15, wherein the fluid that drives said turbine is one or more of wind, ocean current, tidal current or river current.

21. The system of claim 15, wherein the fluid-driven turbine is tethered under water.

22. The system of claim 15, wherein water discharged from said hydro device is used in a water-utility for district cooling.

23. A method comprising;
A. piping pressurized sea water source to a desalinization process whereby the source water passes through a filtering process, producing a low pressure, fresh water flow and a high pressure, brine flow;
B. piping the brine flow into a hydroelectric facility for generation of electricity;
C. piping the fresh water flow to a water utility for drinking or irrigation water and energy for refrigeration; and,
D. using brine flow discharged from the hydroelectric facility for energy for refrigeration.

24. A system wherein energy harnessed by a number of fluid-driven turbines transmits energy via pressurized fluid flow to a common manifold, which in turn delivers the pressurized fluid flow by way of a transmission pipeline to an onshore station, wherein the pressurized fluid flow propels a hydro-device for large-scale commercial power generation.

25. The system of claim 24, wherein an accumulator is provided at an output pipe to integrate energy storage capacity into the system;
said turbines pressurizing said storage accumulator through injection of fluid into air-filled cavities of an energy storage network, whereby a reserve of stored energy in the form of compressed air is used to drive pressurized fluid to said onshore station, wherein the pressurized fluid flow propels said hydro-device for large-scale commercial power generation.
